(19) United States
(12) Patent Application Publication
(10) Pub. No.: US 2002/0013900 A1
(43) Pub. Date: Jan. 31, 2002

(54) User authentication device and electric commerce system using the device

(75) Inventor: Tatsuhiro Ibuki, Gunma (JP)

Correspondence Address: SUGHRUE, MION, ZINN, MACPEAK & SEAS, 2100 Pennsylvania Avenue, N.W., Washington, DC, 20037-3202, US

(73) Assignee: NEC CORPORATION

(21) Appl. No.: 09/862,699

(22) Filed: May 23, 2001

(30) Foreign Application Priority Data
May 25, 2000 (JP) 2000-155140

(51) Int. Cl. H04L 9/00; G06F 12/14

(52) U.S. Cl. 713/168; 713/200

(57) ABSTRACT

A user information processor 2 comprises a function unit for sending a first authentication number to an authentication information processor 3 and a function unit for converting the first authentication number to a second authentication number using a conversion rule 4 in response to an access permission notification from the authentication information processor 3 and for using the second authentication number as a new first authentication number. The authentication information processor 3 comprises a function unit for making a check in response to the first authentication number, a function unit for sending the access permission notification to the user information processor if a user is authenticated as valid, and a function unit for converting the first authentication number to the second authentication number using the same conversion rule as the conversion rule 4 and for recording the second authentication number into a database 5 as a new first authentication number.

### FIELD OF THE INVENTION

The present invention relates to a user authentication device for authenticating a user using an authentication number transferred over a communication network and to a transaction system using the user authentication device. The authentication number is a credit card number, a personal identification number, an ID number, a password, and so on. Authentication is defined as verifying whether a system user is a registered user or as checking whether a system user has an access right to the system resources and authorizing the user to use system resources (“Communication and network terminology handbook for 2000” Nikkei BP).

### BACKGROUND OF THE INVENTION

One of payment methods used for transactions on the Internet is to pay with a credit card. A conventional method for paying with a credit card is that a shopper sends the name and the credit card number from a user terminal to the sales center and the sales center accesses the credit card company for accounts settlement.

### SUMMARY OF THE DISCLOSURE

However, the conventional method has problems described below.

Data is transferred between the user terminal and the sales center terminal and between the sales center terminal and the credit card company terminal over the Internet. This means that someone else might steal information on the Internet. As a result, there is a danger that the stealer will misuse a stolen credit card number intentionally. That is, the stealer pretends to be the owner of the credit card.

In view of the foregoing, it is an object of the present invention to provide a user authentication device that prevents the intentional misuse of a credit card number even if the credit card number transferred over a communication network is stolen and to provide a transaction system using this user authentication device.

FIG. 1 shows a user authentication device according to aspect 1, FIG. 1(1) is a block diagram, and FIG. 1(2) is a sequence diagram. The user authentication device will be described below with reference to the drawings.

The user authentication device according to aspect 1 comprises a user information processor 2 and an authentication information processor 3 that are connected over a communication network 1. The user information processor 2 comprises a function unit (termed hereafter simply “function”) for sending a first authentication number to the authentication information processor 3; and a function for converting the first authentication number to a second authentication number using a predetermined conversion rule 4 in response to an access permission notification from the authentication information processor 3 and for using the second authentication number as a new first authentication number. The authentication information processor 3 comprises a function for making a check using a database 5 in response to the first authentication number from the user information processor 2; a function for sending the access permission notification to the user information processor 2 if a user is authenticated as valid as a result of the check; and a function for converting the first authentication number to the second authentication number using the same conversion rule 4 after sending the access permission notification and for recording the second authentication number into the database 5 as the new first authentication number.

First, the user information processor 2 sends the first authentication number to the authentication information processor 3 (step 101). The authentication information processor 3 checks the database 5 for the validity of the authentication number in response to the first authentication number (step 102). If the user is authenticated as valid as a result of this check, the authentication information processor 3 sends the access permission notification to the user information processor 2 (step 103). Then, the authentication information processor 3 converts the first authentication number to a second first authentication number using the conversion rule 4 (step 104) and records the second authentication number in the database 5 as a new first authentication number (step 105). On the other hand, in response to the access permission notification, the user information processor 2 converts the first authentication number to the second authentication number using the conversion rule 4 and uses the second authentication number as a new first authentication number (step 106). If the user is not recognized as valid in the check in step 102, the subsequent processing is not performed.

Now, assume that a person other than a valid user knows an authentication number via the communication network 1. Also assume that the person attempts to access the authentication information processor 3 using the authentication number. However, because the authentication number has already been converted in the authentication information processor 3, the access is not allowed. Therefore, an unauthorized access by a “pretender” is prevented. Because the authentication number is converted in the user information processor 2 using the same conversion rule as that used in the authentication information processor 3, the user can access the authentication information processor 3 using the converted authentication number.

The user information processor 2 is a cellular phone containing a microcomputer, a personal computer, and so on. The authentication information processor 3 is a server computer, a personal computer, and so on. The authentication number is a credit card number, a personal identification number, an ID number, a password and so on. The user is an individual, a corporate, a group composed of a plurality of persons, and so on.

Next, as more specific concepts of the user authentication device according to aspect 1, the user authentication devices according to aspects 2-4 in which the user authentication device comprises a portable recording medium will be described.

FIG. 2 shows a user authentication device according to aspect 2, FIG. 2(1) is a block diagram, and FIG. 2(2) is a sequence diagram. The user authentication device will be described below with reference to the drawings.

The user authentication device according to aspect 2 is the user authentication device according to aspect 1, wherein the user information processor 2 comprises a portable recording medium 6. The user information processor 2 comprises a function for reading a first authentication number and a predetermined conversion rule 4 from the portable recording medium 6 and for sending the first authentication number to the authentication information processor 3; and a function for converting the first authentication number to a second authentication number using the conversion rule 4 in response to the access permission notification and for recording the second authentication number on the portable recording medium 6 as a new first authentication number.

First, the user information processor 2 reads the first authentication number and the predetermined conversion rule 4 from the portable recording medium 6 (steps 110, 111), and sends the first authentication number to the authentication information processor 3 (step 101). In response to the first authentication number, the authentication information processor 3 checks the database 5 for the validity of the authentication number (step 102). If the user is authenticated as valid as a result of the check, the authentication information processor 3 sends the access permission notification to the user information processor 2 (step 103). Then, the authentication information processor 3 converts the first authentication number to a second authentication number using the conversion rule 4 (step 104) and records the second authentication number into the database 5 as a new first authentication number (step 105). On the other hand, in response to the access permission notification, the user information processor 2 converts the first authentication number to a second authentication number using the conversion rule 4 (step 106) and records the second authentication number on the portable recording medium 6 as a new first authentication number (steps 112, 113).

The user authentication device according to aspect 2 performs the same operation, and gives the same advantage, as that of the user authentication device according to aspect 1. A magnetic card is suitable for the portable recording medium 6 because the medium needs to have a memory capacity large enough to contain only an authentication number and a conversion rule. In this case, the user information processor 2 must comprise a card reader/writer.

FIG. 3 shows a user authentication device according to aspect 3, FIG. 3(1) is a block diagram, and FIG. 3(2) is a sequence diagram. The user authentication device will be described below with reference to the drawings.

The user authentication device according to aspect claim 3 is the user authentication device according to aspect claim 1, wherein the user information processor 2 comprises a portable recording medium 6. The user information processor 2 comprises a function for reading a first authentication number from the portable recording medium 6 and for sending the first authentication number to the authentication information processor 3. The portable recording medium 6 comprises a function for converting the first authentication number to a second authentication number using a predetermined conversion rule 4 in response to the access permission notification and for recording the second authentication number on the portable recording medium 6 as a new first authentication number.

First, the user information processor 2 reads the first authentication number from the portable recording medium 6 (steps 120, 121) and sends the first authentication number to the authentication information processor 3 (step 101). In response to the first authentication number, the authentication information processor 3 checks the database 5 for the validity of the authentication number (step 102). If the user is authenticated as valid as a result of the check, the authentication information processor 3 sends the access permission notification to the user information processor 2 (step 103). Then, the authentication information processor 3 converts the first authentication number to the second authentication number using the conversion rule 4 (step 104) and records the second authentication number into the database 5 as a new first authentication number (step 105). On the other hand, when the user information processor 2 receives the access permission notification (step 122), the portable recording medium 6 converts the first authentication number to the second authentication number using the conversion rule 4 (step 123) and records the second authentication number on the portable recording medium 6 as a new first authentication number (steps 124).

The user authentication device according to aspect 3 performs the same operation, and gives the same advantage, as that of the user authentication device according to aspect 1. An IC card is suitable for the portable recording medium 6 because the operation function for converting the authentication number is required. In this case, the user information processor 2 must comprise an IC card connector.

FIG. 4 shows a user authentication device according to aspect 4, FIG. 4(1) is a block diagram, and FIG. 4(2) is a sequence diagram. The user authentication device will be described below with reference to the drawings.

The user authentication device according to aspect 4 is the user authentication device according to aspect 1, wherein the user information processor 2 comprises a portable recording medium 6. The user information processor 2 comprises a function for receiving a first authentication number and sending the first authentication number to the authentication information processor 3; and a function for reading a predetermined conversion rule from the portable recording medium 6, for converting the first authentication number to a second authentication number using the conversion rule 4 in response to the access permission notification, and for outputting the second authentication number as a new first authentication number.

First, the user information processor 2 receives the first authentication number (steps 130) and sends the first authentication number to the authentication information processor 3 (step 101). In response to the first authentication number, the authentication information processor 3 checks the database 5 for the validity of the authentication number (step 102). If the user is authenticated as valid as a result of the check, the authentication information processor 3 sends the access permission notification to the user information processor 2 (step 103). Then, the authentication information processor 3 converts the first authentication number to a second authentication number using the conversion rule 4 (step 104) and records the second authentication number into the database 5 as a new first authentication number (step 105). On the other hand, in response to the access permission notification, the user information processor 2 reads the predetermined conversion rule 4 from the portable recording medium 6 (steps 131, 132), converts the first authentication number to a second authentication number using the conversion rule 4 (step 133) and outputs the second authentication number as a new first authentication number (steps 134).

The user authentication device according to aspect 4 also performs the same operation, and gives the same advantage, as that of the user authentication device according to aspect 1. The first authentication number in step 130 is input, for example, from the keyboard by the user. The new first authentication number in step 134 is displayed, for example, on the display that only the user can view. A magnetic card is suitable for the portable recording medium 6 because it needs to have a memory capacity large enough to contain only the conversion rule. A personal identification number is suitable for the authentication number because it is not recorded on the portable recording medium 6. Note that, if the conversion rule is recorded in the user information processor 2, the portable recording medium 6 is not required and, in this case, the authentication device according to aspect 1 satisfies this requirement.

FIG. 5 shows a user authentication device according to aspect 5, FIG. 5 (1) is a block diagram, and FIG. 5 (2) is a sequence diagram. The user authentication device will be described below with reference to the drawings.

The user authentication device according to aspect 5 comprises a user information processor 2, a mediator information processor 7, and an authentication information processor 3 connected over a communication network 1. The user information processor 2 comprises a function for sending a first authentication number to the mediator information processor 7; and a function for receiving a second authentication number from the mediator information processor 7, for converting the second authentication number to a third authentication number using a predetermined conversion rule 4, and for using the third authentication number as a new first authentication number. The mediator information processor 7 comprises a function for sending the first authentication number to the authentication information processor 3, the first authentication number being received from the user information processor 2; and a function for receiving the second authentication number from the authentication information processor 3 and for sending the second authentication number to the user information processor 2. The authentication information processor 3 comprises a function for making a check using a database 5 in response to the first authentication number from the mediator information processor 7 and for sending the second authentication number to the mediator information processor 7 if a user is authenticated as valid as a result of the check, the second authentication number being different from the first authentication number; and a function for converting the second authentication number to a third authentication number using the same conversion rule 4 and for recording the third authentication number into the database 5 as a new first authentication number.

First, the user information processor 2 sends the first authentication number to the mediator information processor 7 (step 140). The mediator information processor 7 sends the first authentication number to the authentication information processor 3 (step 141). In response to the first authentication number, the authentication information processor 3 checks the database 5 for the validity of the authentication number (step 142). If the user is authenticated as valid as a result of this check, the authentication information processor 3 sends the second authentication number to the mediator information processor 7 (step 143). Then, the authentication information processor 3 converts the second authentication number to a third authentication number using the conversion rule 4 (step 144) and records the third authentication number in the database 5 as a new first authentication number (step 145). On the other hand, the mediator information processor 7 sends the second authentication number to the user information processor 2 (step 146). In response to the second authentication number, the user information processor 2 converts the second authentication number to the third authentication number using the conversion rule 4 and uses the third authentication number as the new first authentication number (step 147). If the user is not recognized as valid in the check in step 142, the subsequent processing is not performed.

Now, assume that a person other than a valid user knows a first or second authentication number via the communication network 1 or the mediator information processor 7. Also assume that the person attempts to access the authentication information processor 3 using the first or second authentication number. However, because the first or second authentication number has already been converted in the authentication information processor 3, the access is not allowed. Therefore, an unauthorized access by a “pretender” is prevented. In addition, because the second authentication number is converted to the third authentication number in the user information processor 2 using the same conversion rule, the user can access the user information processor 2 using the third authentication number.

The user authentication device according to aspect 5 is the user authentication device according to aspect 1 further comprising the mediator information processor 7. The mediator information processor 7 is a server computer, a personal computer, and so on. Because the authentication number may be leaked even in the mediator information processor 7, the second authentication number is used in addition to the first authentication number as a dummy (substitute) authentication number.

Like the user authentication devices according to aspects 2-4, the user authentication device according to aspect 5 may include a portable recording medium into the user information processor. The user authentication devices according to aspects 6-8 will be described below.

FIG. 6 shows a user authentication device according to aspect 6, FIG. 6(1) is a block diagram, and FIG. 6(2) is a sequence diagram. The user authentication device will be described below with reference to the drawings.

The user authentication device according to aspect 6 is a user authentication device, wherein the user information processor 2 comprises a portable recording medium 6. The user information processor 2 comprises a function for reading a first authentication number and a predetermined conversion rule 4 from the portable recording medium 6 and for sending the first authentication number to the mediator information processor 7; and a function for converting the second authentication number to a third authentication number using the conversion rule 4 in response to the second authentication number and for recording the second authentication number on the portable recording medium 6 as a new first authentication number.

First, the user information processor 2 reads the first authentication number and the predetermined conversion rule 4 from the portable recording medium 6 (steps 150, 151) and sends the first authentication number to the mediator information processor 7 (step 140). The mediator information processor 7 sends the first authentication number to the authentication information processor 3 (step 141). In response to the first authentication number, the authentication information processor 3 checks the database 5 for the validity of the authentication number (step 142). If the user is authenticated as valid as a result of the check, the authentication information processor 3 sends the second authentication number to the mediator information processor 7 (step 143). Then, the authentication information processor 3 converts the second authentication number to a third authentication number using the conversion rule 4 (step 144) and records the third authentication number into the database 5 as a new first authentication number (step 145). On the other hand, the mediator information processor 7 sends the second authentication number to the user information processor 2 (step 146). In response to the second authentication number, the user information processor 2 converts the second authentication number to a third authentication number using the conversion rule 4 (step 147) and records the third authentication number on the portable recording medium 6 as a new first authentication number (steps 152, 153).

The user authentication device according to aspect 6 also performs the same operation, and gives the same advantage, as that of the user authentication device according to aspect 5. A magnetic card is suitable for the portable recording medium 6 because the medium needs to have a memory capacity large enough to contain only an authentication number and a conversion rule. In this case, the user information processor 2 must comprise a card reader/writer.

FIG. 7 shows a user authentication device according to aspect 7, FIG. 7(1) is a block diagram, and FIG. 7(2) is a sequence diagram. The user authentication device will be described below with reference to the drawings.

The user authentication device according to aspect 7 is a user authentication device, wherein the user information processor 2 comprises a portable recording medium 6. The user information processor 2 comprises a function for reading a first authentication number from the portable recording medium 6 and for sending the first authentication number to the mediator information processor 7. The portable recording medium 6 comprises a function for converting the second authentication number to a third authentication number using a predetermined conversion rule 4 in response to the second authentication number and for recording the third authentication number on the portable recording medium 6 as a new first authentication number.

First, the user information processor 2 reads the first authentication number from the portable recording medium 6 (steps 160, 161) and sends the first authentication number to the mediator information processor 7 (step 140). The mediator information processor 7 sends the first authentication number to the authentication information processor 3 (step 141). In response to the first authentication number, the authentication information processor 3 checks the database 5 for the validity of the authentication number (step 142). If the user is authenticated as valid as a result of the check, the authentication information processor 3 sends the second authentication number to the mediator information processor 7 (step 143). Then, the authentication information processor 3 converts the second authentication number to a third authentication number using the conversion rule 4 (step 144) and records the third authentication number into the database 5 as a new first authentication number (step 145). On the other hand, the mediator information processor 7 sends the second authentication number to the user information processor 2 (step 146). When the user information processor 2 receives the second authentication number (step 162), the portable recording medium 6 converts the second authentication number to a third authentication number using the conversion rule 4 (step 163) and records the third authentication number on the portable recording medium 6 as a new first authentication number (steps 164).

The user authentication device according to aspect 7 also performs the same operation, and gives the same advantage, as that of the user authentication device according to aspect 5. An IC card is suitable for the portable recording medium 6 because the operation function for converting the authentication number is required. In this case, the user information processor 2 must comprise an IC card connector.

FIG. 8 shows a user authentication device according to aspect 8, FIG. 8(1) is a block diagram, and FIG. 8(2) is a sequence diagram. The user authentication device will be described below with reference to the drawings.

The user authentication device according to aspect 8 is a user authentication device, wherein the user information processor 2 comprises a portable recording medium 6. The user information processor 2 comprises a function for receiving a first authentication number and sending the first authentication number to the mediator information processor 7; and a function for reading a predetermined conversion rule 4 from the portable recording medium 6, for converting the second authentication number to a third authentication number using the conversion rule 4 in response to the second authentication number, and for outputting the third authentication number as a new first authentication number.

First, the user information processor 2 receives the first authentication number (steps 170) and sends the first authentication number to the mediator information processor 7 (step 140). The mediator information processor 7 sends the first authentication number to the authentication information processor 3 (step 141). In response to the first authentication number, the authentication information processor 3 checks the database 5 for the validity of the authentication number (step 142). If the user is authenticated as valid as a result of the check, the authentication information processor 3 sends the second authentication number to the mediator information processor 7 (step 143). Then, the authentication information processor 3 converts the second authentication number to the third authentication number using the conversion rule 4 (step 144) and records the third authentication number into the database 5 as a new first authentication number (step 145). On the other hand, the mediator information processor 7 sends the second authentication number to the user information processor 2 (step 146). In response to the second authentication number, the user information processor 2 reads the predetermined conversion rule 4 from the portable recording medium 6 (steps 171, 172), converts the second authentication number to a third authentication number using the conversion rule 4 (step 173) and outputs the third authentication number as a new first authentication number (step 174).

The user authentication device according to aspect 8 also performs the same operation, and gives the same advantage, as that of the user authentication device according to aspect 5. The first authentication number in step 170 is input, for example, from the keyboard by the user. The new first authentication number in step 174 is displayed, for example, on a display that only the user can view. A magnetic card is suitable for the portable recording medium 6 because it needs to have a memory capacity large enough to contain only the conversion rule. A personal identification number is suitable for the authentication number because it is not recorded on the portable recording medium 6. Note that, if the conversion rule is recorded in the user information processor 2, the portable recording medium 6 is not required and, in this case, the authentication device according to aspect 5 satisfies this requirement.

A transaction system according to aspect 9 uses the user authentication device according to aspect 2 or 3. The transaction system will be described with reference to FIGS. 2 and 3.

The user information processor 2 sends the first authentication number and an accounts-settlement request to the authentication information processor 3. The authentication information processor 3 executes the check and account-settlement processing. The communication network 1 is the Internet, the user information processor 2 is a terminal in a retail store, the authentication information processor 3 is a credit card company terminal, the portable recording medium 6 is a credit card, and the authentication number is a credit card number.

A transaction system according to aspect 10 uses the user authentication device according to aspect 4. The transaction system will be described with reference to FIGS. 4.

The user information processor 2 sends the first authentication number and an accounts-settlement request to the authentication information processor 3. The authentication information processor 3 executes the check and account-settlement processing. The communication network 1 is the Internet, the user information processor 2 is a terminal in a retail store, the authentication information processor 3 is a banking terminal, the portable recording medium 6 is a cash card, and the authentication number is a personal identification number.

A transaction system according to aspect 11 uses the user authentication device according to aspect 6 or 7. The transaction system will be described with reference to FIG. 6 or 7.

The mediator information processor 7 sends the first authentication number and an accounts-settlement request to the authentication information processor 3. The authentication information processor 3 executes the check and account-settlement processing. The communication network 1 is the Internet, the user information processor 2 is a user terminal, the mediator information processor 7 is a sales center terminal, the authentication information processor 3 is a credit card company terminal, the portable recording medium 6 is a credit card, and the authentication number is a credit card number.

A transaction system according to aspect 12 uses the user authentication device according to aspect 8. The transaction system will be described with reference to FIG. 8.

The mediator information processor 7 sends the first authentication number and an accounts-settlement request to the authentication information processor 3. The authentication information processor 3 executes the check and account-settlement processing. The communication network 1 is the Internet, the user information processor 2 is a user terminal, the mediator information processor 7 is a sales center terminal, the authentication information processor 3 is a banking terminal, the portable recording medium 6 is a cash card, and the authentication number is a personal identification number.

According to further aspects of the present invention, there are provided user authentication methods and transaction methods using same.

As described above, the present invention provides a business model that locally converts a credit card number when a credit card is used in accounts settlement in a transaction on the Internet. This business model prevents a credit card number from being misused intentionally even if it is stolen on a network.

### BRIEF DESCRIPTION OF THE DRAWINGS

FIG. 1 shows a user authentication device according to claim 1, FIG. 1(1) is a block diagram, and FIG. 1(2) is a sequence diagram.

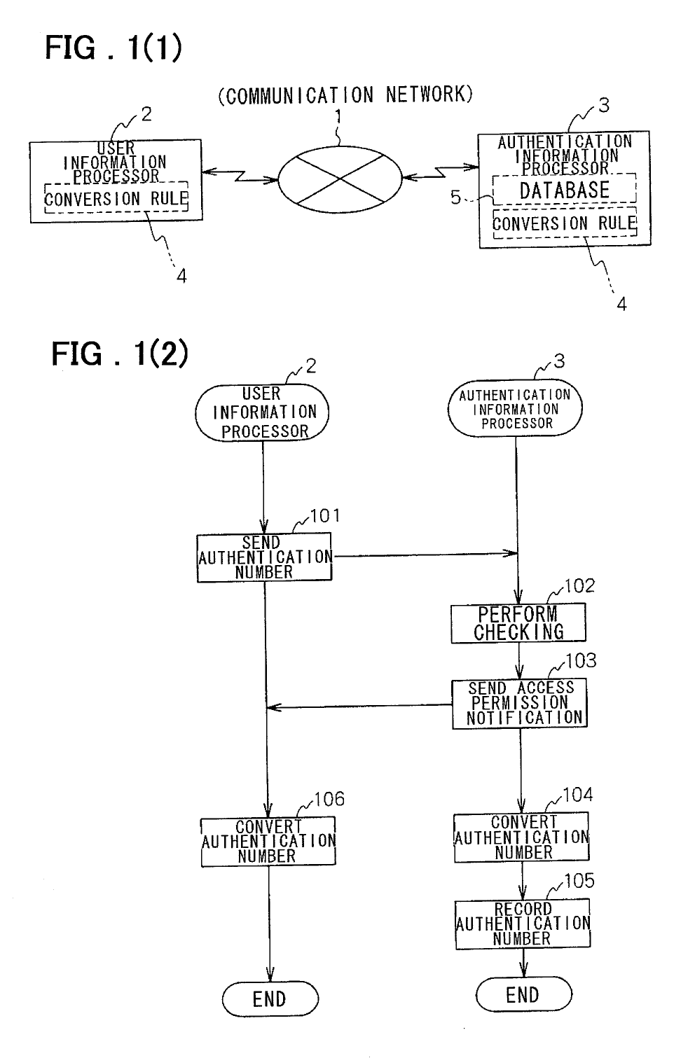

FIG. 2 shows a user authentication device according to claim 2, FIG. 2(1) is a block diagram, and FIG. 2(2) is a sequence diagram.

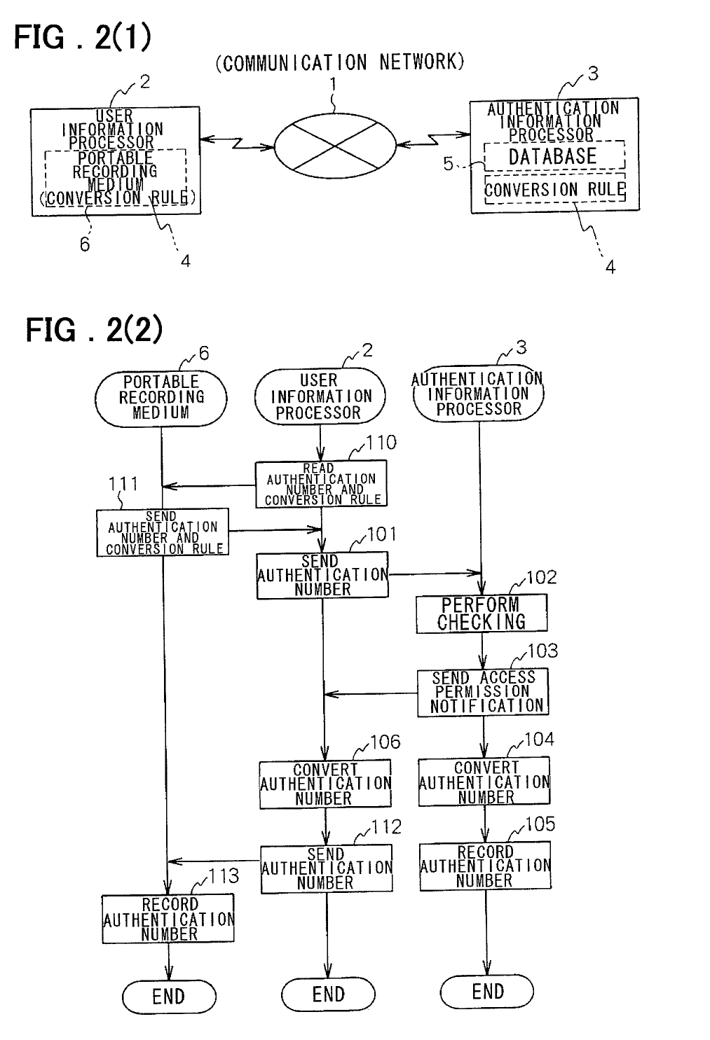

FIG. 3 shows a user authentication device according to claim 3, FIG. 3(1) is a block diagram, and FIG. 3(2) is a sequence diagram.

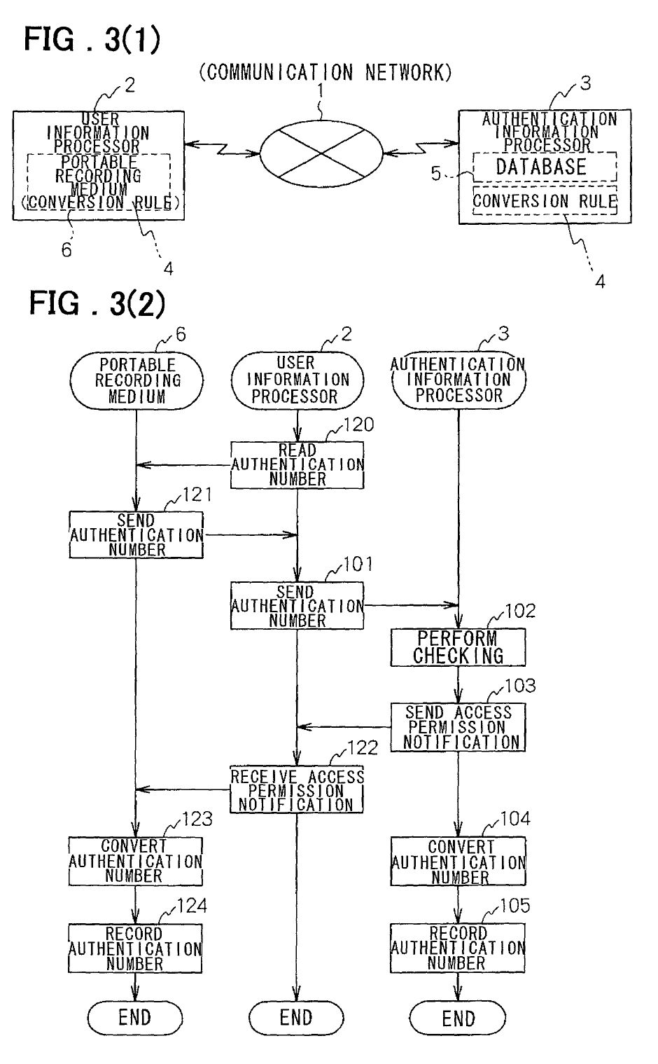

FIG. 4 shows a user authentication device according to claim 4, FIG. 4(1) is a block diagram, and FIG. 4(2) is a sequence diagram.

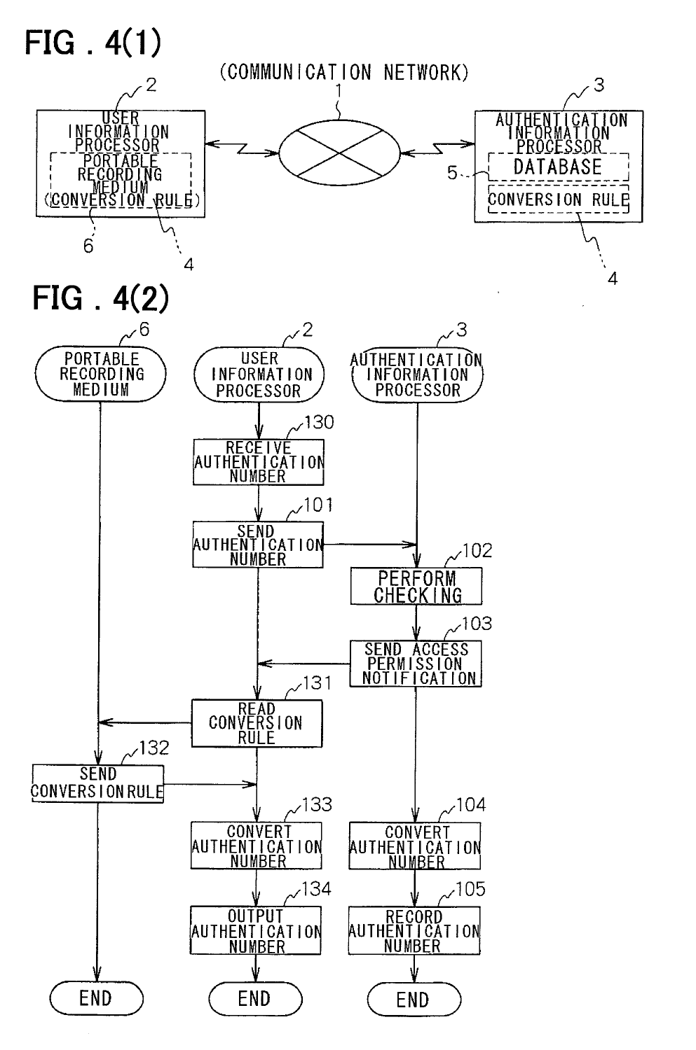

FIG. 5 shows a user authentication device according to claim 5, FIG. 5(1) is a block diagram, and FIG. 5(2) is a sequence diagram.

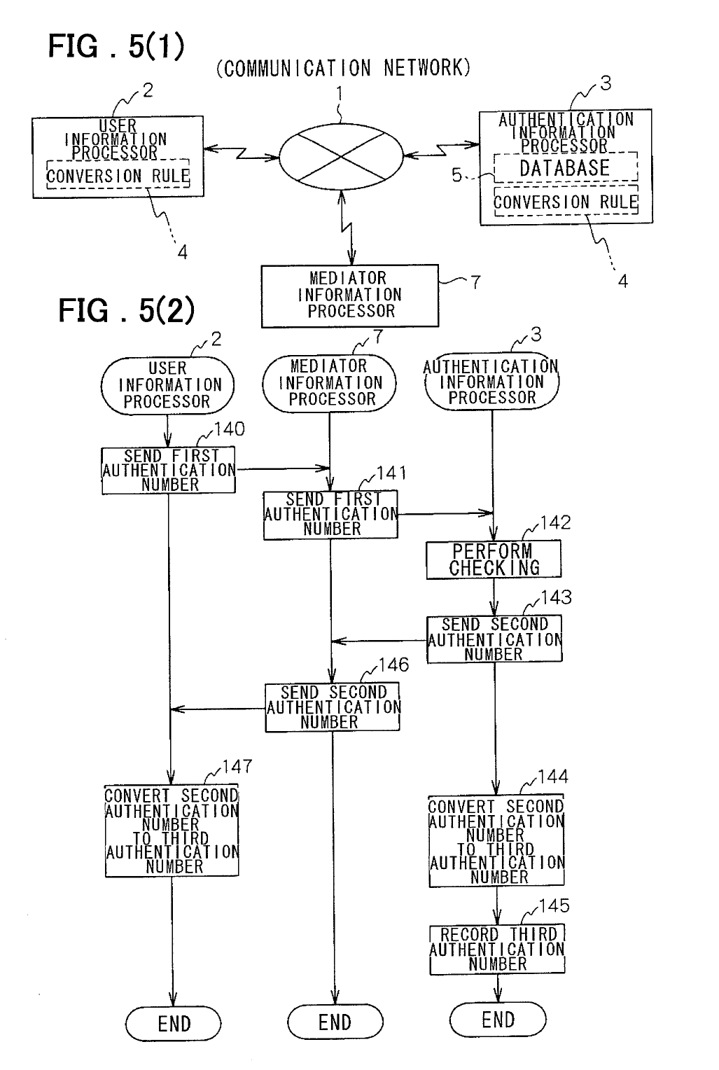

FIG. 6 shows a user authentication device according to claim 6, FIG. 6(1) is a block diagram, and FIG. 6(2) is a sequence diagram.

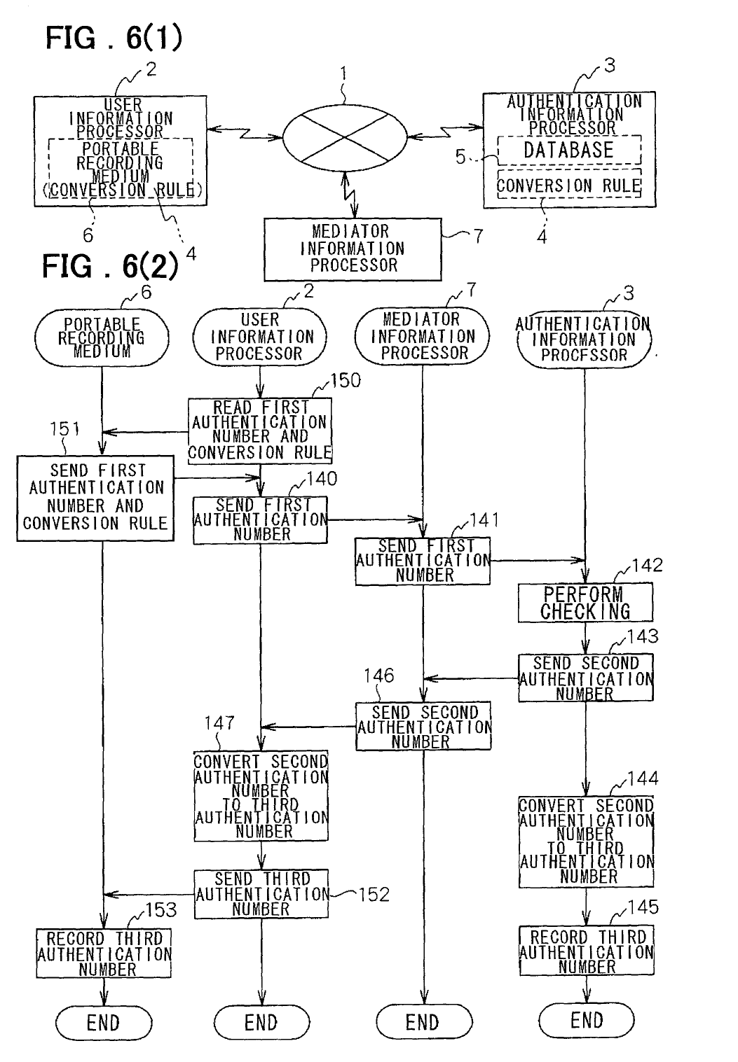

FIG. 7 shows a user authentication device according to claim 7, FIG. 7(1) is a block diagram, and FIG. 7(2) is a sequence diagram.

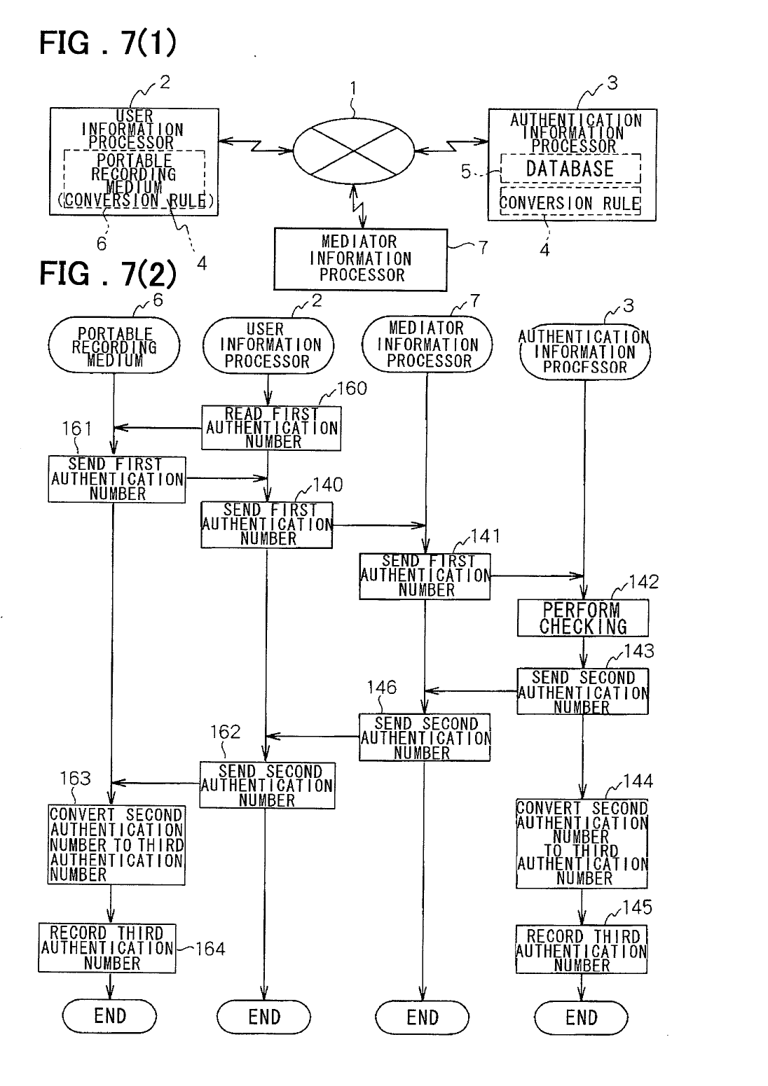

FIG. 8 shows a user authentication device according to claim 8, FIG. 8(1) is a block diagram, and FIG. 8(2) is a sequence diagram.

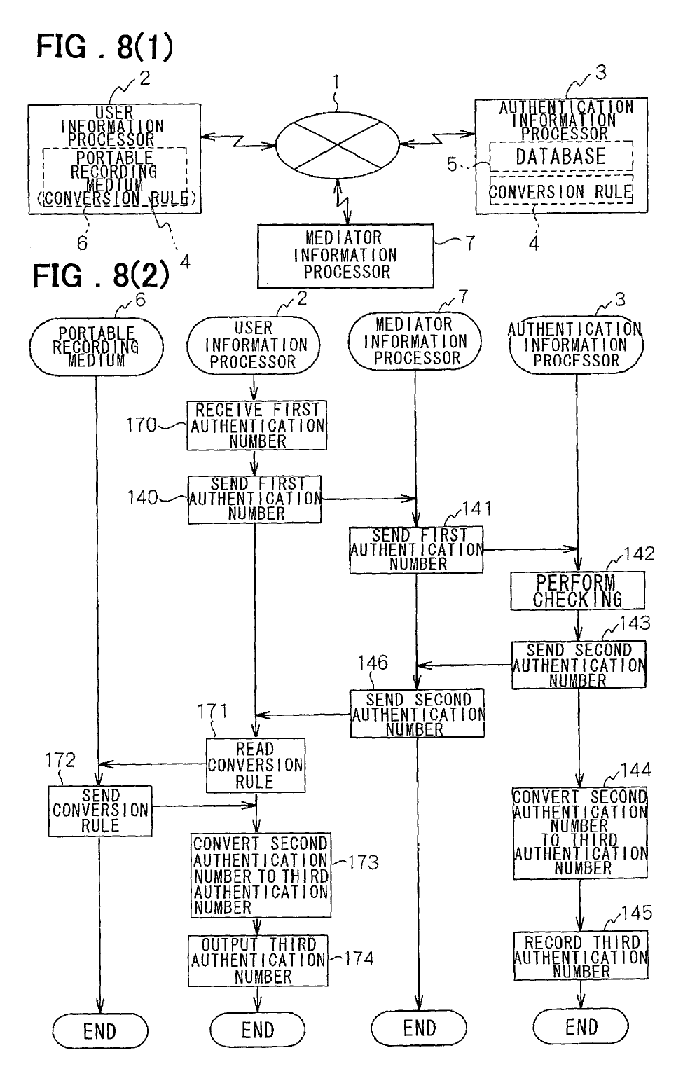

FIG. 9 is a block diagram showing a first embodiment of a transaction system of the present invention.

FIG. 10 is a sequence diagram showing the operation of the first embodiment of the transaction system according to the present invention.

FIG. 11 is a sequence diagram showing the operation of the first embodiment of the transaction system according to the present invention.

FIG. 12 is a sequence diagram showing the operation of the first embodiment of the transaction system according to the present invention.

FIG. 13 shows a user terminal display screen in the first embodiment, FIG. 13(1) shows a first example, and FIG. 13(2) shows a second example.

FIG. 14 is a sequence diagram showing the operation of a second embodiment of the transaction system according to the present invention.

FIG. 15 is a sequence diagram showing the operation of the second embodiment of the transaction system according to the present invention.

FIG. 16 is a sequence diagram showing the operation of the second embodiment of the transaction system according to the present invention.

### PREFERRED EMBODIMENTS OF THE INVENTION

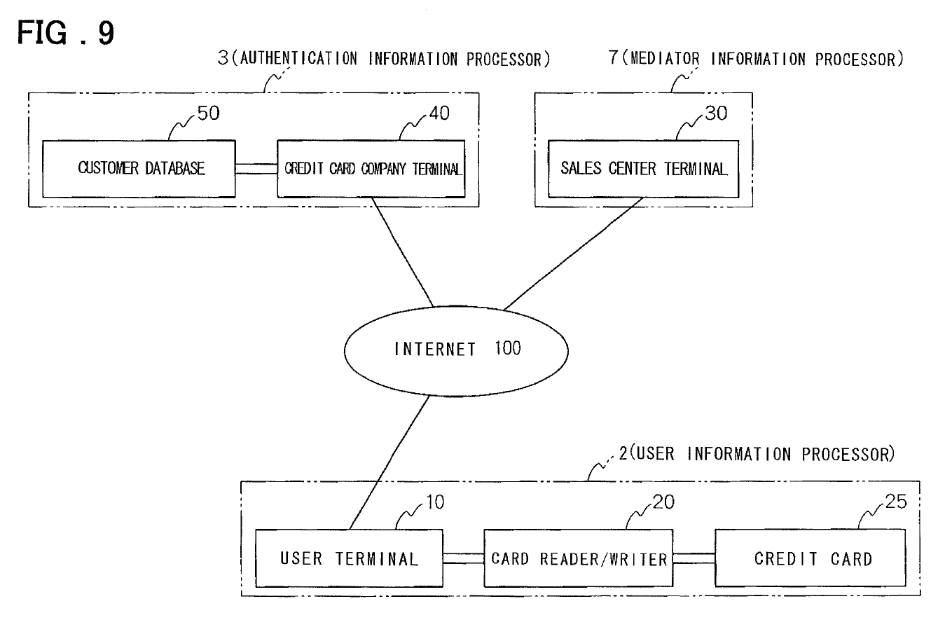

FIG. 9 is a block diagram showing a first embodiment of a transaction system according to the present invention. The embodiment will be described with reference to the drawings.

A user information processor 2 comprises a user terminal 10 that has a card reader/writer 20 and a credit card 25. A mediator information processor 7 comprises a sales center terminal 30. An authentication information processor 3 comprises a credit card company terminal 40 that has a customer database 50.

A shopper sends an order of a product to the sales center terminal 30 using the user terminal 10. At this time, the user terminal 10 accesses the credit card 25 via the card reader/writer 20, reads the recorded credit card number and, at the same time, sends the credit card number to the sales center terminal 30. The sales center terminal 30 sends a request to the credit card company terminal 40 to settle the account of the received credit card number. In response to the account settlement request, the credit card company terminal 40 accesses the customer database 50 for settlement. After the settlement, the credit card company terminal 40 sends a settlement completion notification and a new credit card number to the sales center terminal 30. In response to this notification, the sales center terminal 30 sends a transaction completion notification and the new credit card number to the user terminal 10. Upon receiving the new credit card number, the user terminal 10 uses a conversion rule recorded on the credit card 25 to convert the credit card number and then records the converted credit card number on the credit card 25. On the other hand, the customer database 50 also uses the same conversion rule recorded in the customer database 50 to convert the new credit card number and records the converted credit card number in the customer database 50. The next time the shopper does a transaction, the converted credit card number will be used.

That is, the transaction system in this embodiment comprises the user terminal 10, the card reader/writer 20 locally connected to the user terminal 10, the credit card 25 to be inserted into the card reader/writer 20, the sales center terminal 30, the credit card company terminal 40, the customer database 50 locally connected to the credit card company terminal 40, and the Internet 100 interconnecting the user terminal 10, sales center terminal 30, and credit card company terminal 40.

The user terminal 10 is an information processor such as a personal computer. The user terminal 10 accesses the sales center terminal 30 via the Internet 100 to send or receive data to or from the sales center terminal 30. The user terminal 10 has a screen output function that displays received information on the screen as well as an input function that allows a shopper to select a product he or she wants or to enter information such as address information. In addition, the user terminal 10 reads information from the credit card 25 via the card reader/writer 20 and records information on the credit card 25 via the card reader/writer 20. Moreover, the user terminal 10 uses the conversion rule read from the credit card 25 to convert the credit number.

The card reader/writer 20, a device used to write or read information to or from the credit card 25, is locally connected to the user terminal 10. In response to a read request from the user terminal 10, the card reader/writer 20 reads information from the credit card 25 and sends the information to the user terminal 10. Also, in response to a write request from the user terminal 10, the card reader/writer 20 writes information, received from the user terminal 10, onto the credit card 25.

The credit card 25 is a medium on which specific information, which is supplied from the credit card company to the shopper, is recorded. When the shopper makes a contract with the credit card company, the credit card 25 is created with information recorded thereon and then handed or mailed to the shopper. Recorded information includes a credit card number and a credit card conversion rule. The credit card number may be read and written by the card reader/writer 20, while the credit card number conversion rule may only be read. In the description below, it is assumed that the credit card 25 is inserted in the card reader/writer 20 and is ready for reading and writing.

The sales center terminal 30 is an information processor such as a workstation server. The sales center terminal 30 sends or receives information to or from the user terminal 10 and credit card company terminal 40 over the Internet 100. The sales center terminal 30 also calculates an amount from received order information and ships the product.

The credit card company terminal 40 is an information processor such as a personal computer. The credit card company terminal 40 sends or receives information to or from the sales center terminal 30 over the Internet 100 or to or from the locally connected customer database 50.

The customer database 50 is an information processor such as a workstation server. The customer database 50 contains information on the customers. Recorded information includes personal information such as a credit card number and a name and a credit card number conversion rule. The credit card number and the credit card number conversion rule are the same as those recorded on the credit card 25. The customer database 50, locally connected to the credit card company terminal 40, sends or receives information to or from the credit card company terminal 40. The customer database 50 checks the credit card number and transaction amounts and generate new credit card numbers. The customer database 50 also uses the credit card number conversion rule recorded therein to convert a credit card number and records the converted credit card number into the customer database 50.

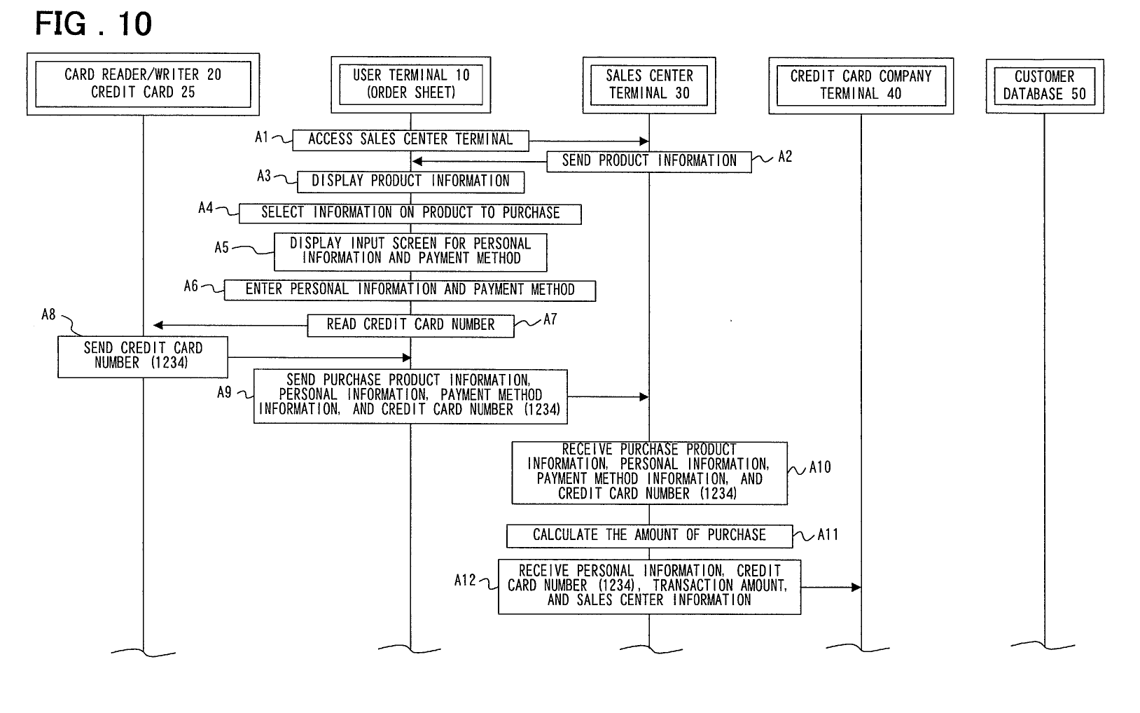

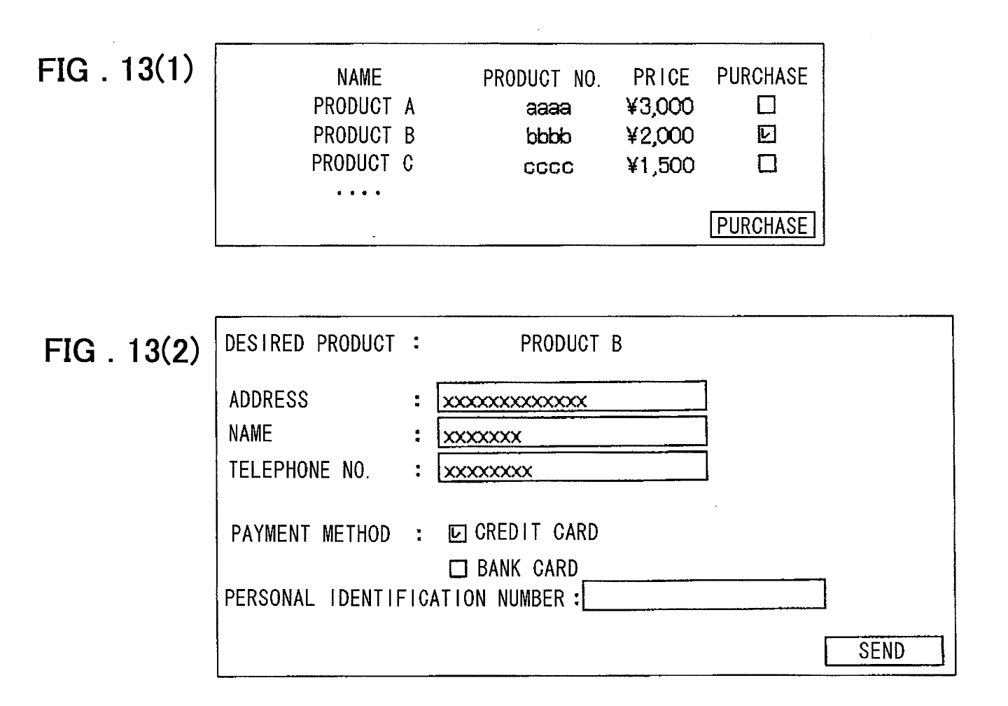

FIGS. 10-12 are sequence diagrams showing the operation of the transaction system in this embodiment. FIG. 13 shows screens displayed on the user terminal. FIG. 13(1) shows a first example, and FIG. 13(2) shows a second example. The operation of the transaction system in this embodiment will be described below with reference to FIGS. 9-13.

It is assumed that the data is transferred between the user terminal 10 and the sales center terminal 30 and between the sales center terminal 30 and the credit card company terminal 40 over the Internet 100. It is also assumed that data is transferred locally between the user terminal 10 and the card reader/writer 20, and the credit card 25 and between the credit card company terminal 40 and the customer database 50.

First, the shopper uses the user terminal 10 to access the product sales web page created on the Internet 100 by the sales center (step A1 in FIG. 10). In response to this access, the sales center terminal 30 sends product information to the user terminal 10 (step A2 in FIG. 10). The user terminal 10, which has received the product information, displays it in the format shown in FIG. 13(1) (step A3 in FIG. 10). The shopper views the product information displayed on the screen of the user terminal 10, determines the product he or she wants to purchase, and fills out the screen to indicate that he or she is going to purchase the product (step A4 in FIG. 10). In the example shown in FIG. 13(1), when the shopper clicks the purchase column of product B with a mouse, the check mark appears in the column to indicate that product B has been selected for purchase. Information on the product the shopper has selected to purchase is temporarily stored in the user terminal 10.

Next, when the shopper clicks the “Purchase” button on the screen shown in FIG. 13(1), an input form such as the one shown in FIG. 13(2) is displayed on the screen of the user terminal 2 to prompt the shopper to enter information necessary to purchase the product (step A5 in FIG. 10). The shopper confirms the product to purchase and then enters various types of information (step A6 in FIG. 10). Information the shopper enters includes personal information such as the address of the shopper (product delivery address), name, and telephone number, and a payment method. In the example shown in FIG. 13(2), the shopper clicks the check column of credit card 25 of “Payment method” to indicate that the shopper has selected payment by the credit card 25 that is the method proposed by the present invention. This information is stored temporarily in the user terminal 10.

Then, when the shopper clicks the “Send” button on the screen shown in FIG. 13(2), the user terminal 10 accesses the credit card 25 (step A7 in FIG. 10) to read the credit card number from the credit card 25 (step A8 in FIG. 10). As an example, assume that the credit card number 1234 is recorded on the credit card 25. Upon receiving the credit card number 1234 from the credit card 25, the user terminal 10 sends product order information, which is composed of purchase product information, personal information, and payment method information stored in the user terminal 10, as well as the credit card number 1234 that was read, to the sales center terminal 30 (step A9 in FIG. 10).

Upon receiving the product order information (step A10 in FIG. 10), the sales center terminal 30 calculates the total amount from the purchase product information (step A11 in FIG. 10). Then, to settle the accounts with the credit card 25, the sales center terminal 30 sends transaction information, which is composed of shopper's personal information, credit card number 1234, transaction amount, and bank account to which the price is to be transferred (account number of the sales center and so on), to the credit card company terminal 40 (step A12 in FIG. 10).

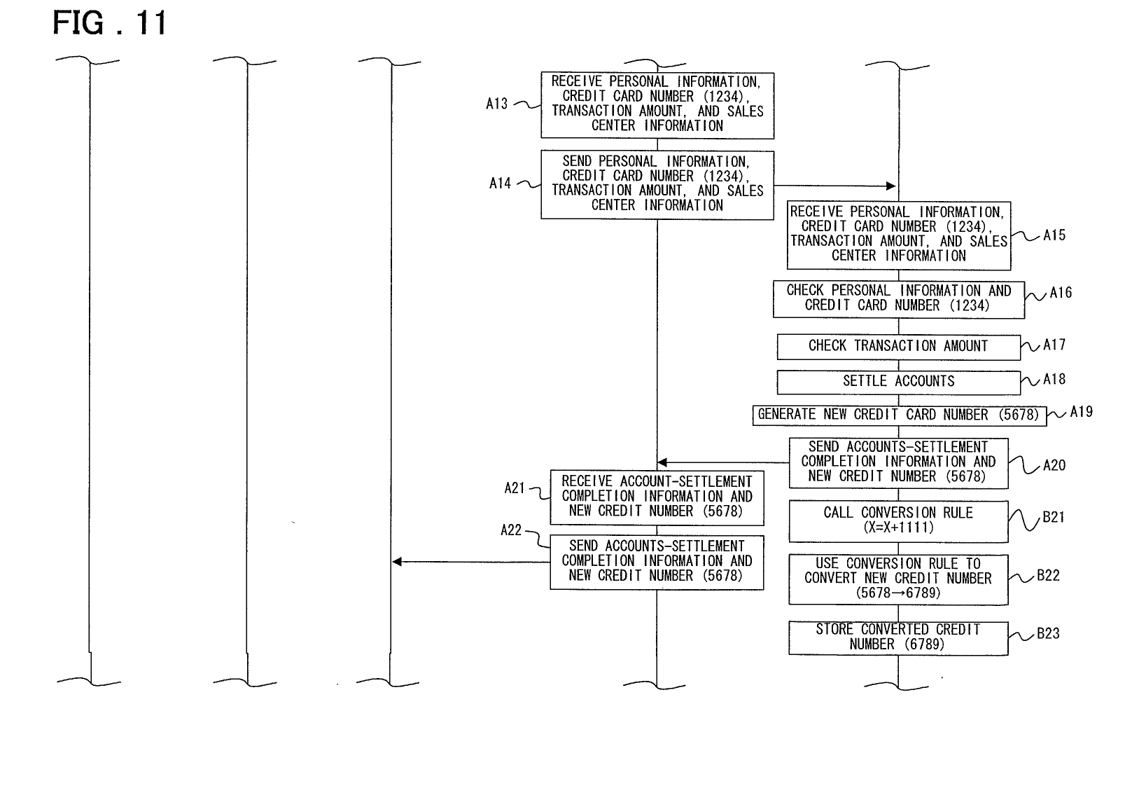

Upon receiving the transaction information (step A13 in FIG. 11), the credit card company terminal 40 sends the information to the customer database 50 (step A14 in FIG. 11) to check the transaction.

Upon receiving the transaction information (step A15 in FIG. 11), the customer database 50 checks the shopper based on the personal information and the credit card number (step A16 in FIG. 11). If the information is incorrect, the customer database 50 sends an incorrect-information message to the shopper via the credit card company terminal 40, sales center terminal 30, and user terminal 10. After checking the shopper, the customer database 50 checks the transaction amount (step A17 in FIG. 11). If it is impossible to perform transaction, for example, if the transaction amount exceeds the allowable amount associated with the credit card 25, the customer database 50 sends an invalid-transaction message to the shopper via the credit card company terminal 40, sales center terminal 30, and user terminal 10. If it is confirmed that there is no problem in performing the transaction, the customer database 50 settles the accounts (step A18 in FIG. 11). After accounts settlement, the customer database 50 generates a new credit card number (step A19 in FIG. 11). As an example, assume that the credit card number 5678 is generated.

The customer database 50 sends accounts settlement completion information indicating that the accounts settlement has been completed and the generated new credit card number 5678 to the credit card company terminal 40 (step A20 in FIG. 11). After that, the customer database 50 calls the conversion rule of the credit card 25 (in this example, add 1111 to the credit card number) recorded in the customer database 50 (step B21 in FIG. 11), uses this conversion rule to convert the generated new credit card number from 5678 to 6789 (step B22 in FIG. 11), and records the converted credit card number 6789 in the customer database 50 (step B23 in FIG. 11).

Upon receiving the accounts settlement completion information and the new credit card number 5678 (step A21 in FIG. 11), the credit card company terminal 40 sends them to the sales center terminal 30 (step A22 in FIG. 11).

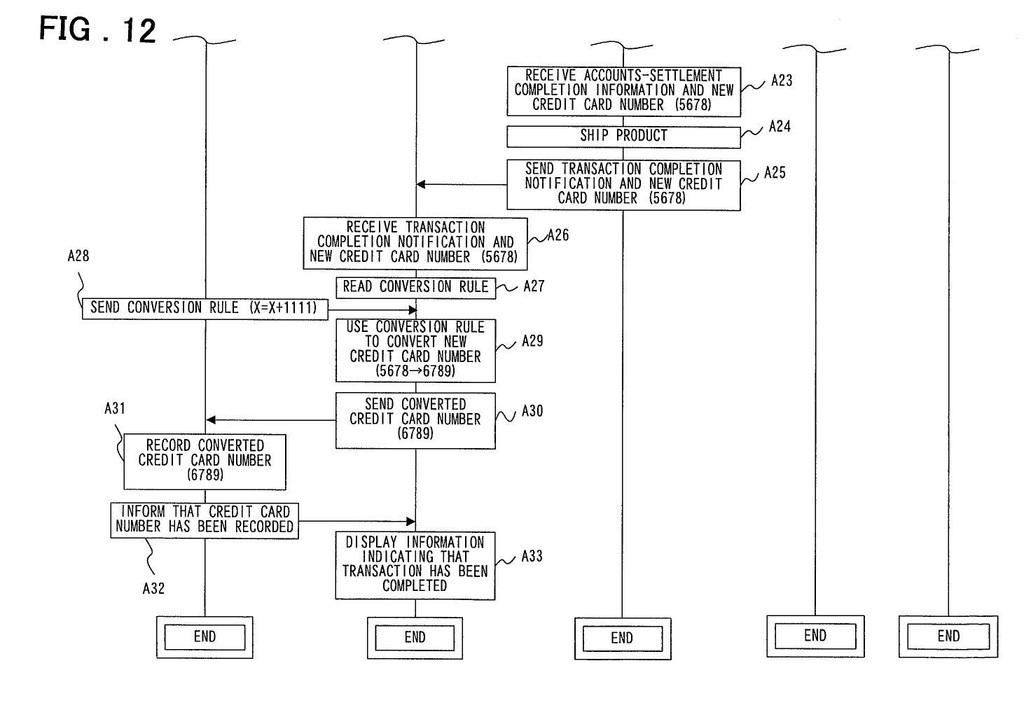

Upon receiving the accounts settlement completion information and the new credit number 5678 (step A23 in FIG. 12), the sales center terminal 30 ships the product (step A24 in FIG. 12). After that, the sales center terminal 30 sends a transaction completion notification indicating that the transaction has been completed and the new credit card number 5678 to the user terminal 10 (step A25 in FIG. 12).

Upon receiving the transaction completion notification and the new credit card number 5678, the user terminal 10 accesses the credit card 25 (step A27 in FIG. 12) to read the recorded conversion rule (x=x+1111) (step A28 in FIG. 12). The user terminal 10 uses this conversion rule to convert the new credit card number from 5678 to 6789 (step A29 in FIG. 12), sends it to the credit card 25 (step A30 in FIG. 12), and records it on the credit card 25 (step A31 in FIG. 12). After the converted credit card number has been recorded (step A32 in FIG. 12), the user terminal 10 displays information indicating that the transaction has been completed (step A33 in FIG. 12) to inform the shopper that the transaction has been completed.

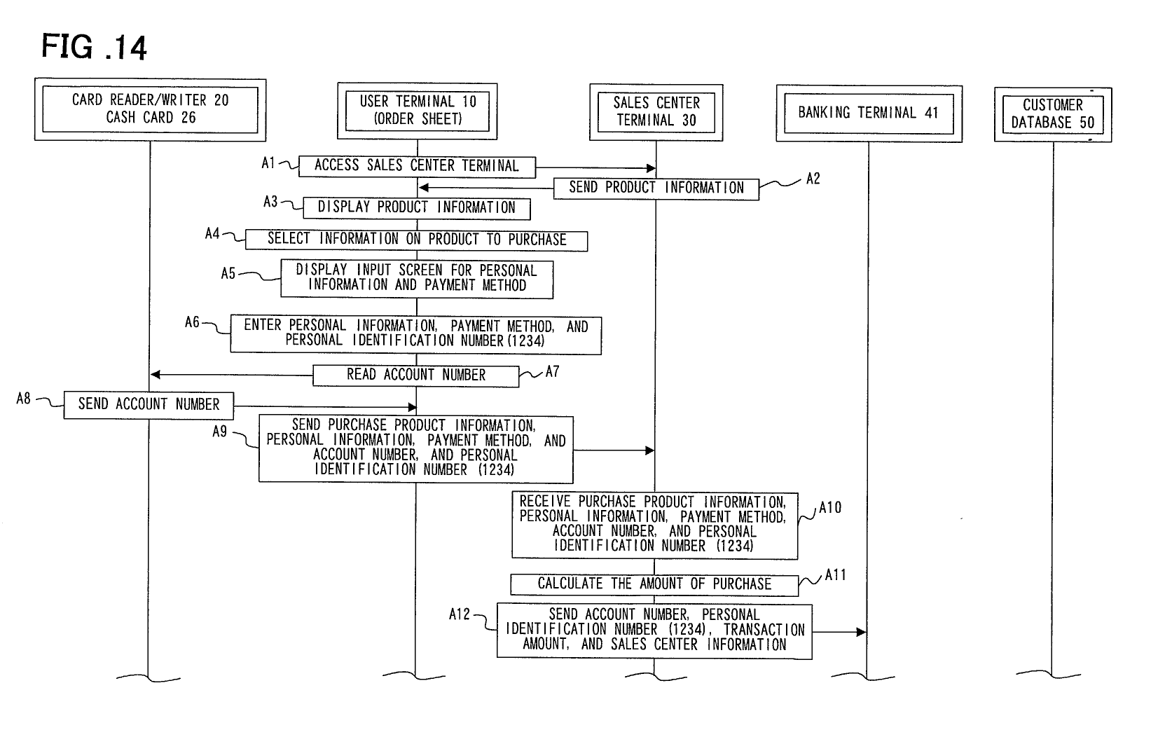

FIGS. 14-16 are sequence diagrams showing the operation of a transaction system in a second embodiment of the present invention. The transaction system in this embodiment will be described below with reference to FIGS. 13-16.

In the transaction system in this embodiment, a cash card 26 and a banking terminal 41 are used instead of the credit card 25 and the credit card company terminal 40 in the first embodiment. The cash card 26 is a medium supplied from a bank to a shopper and recording thereon specific information. The information recorded on the cash card 26 is the account number of the shopper and a personal identification number conversion rule. When settling accounts with the cash card 26, a check is made using a personal identification number. Converting the personal identification number after a transact ion prevents the personal identification number from being misused intentionally even if it is stolen on the Internet 100.

A personal identification number, which is entered manually by the shopper, is not written on the cash card 26. Therefore, the cash card 26 may be read-only. Also, the card reader/writer 20 need to have only the read function. However, the system may be designed such that, like the credit card 25, a personal identification number is read from the cash card 26.

First, the shopper uses the user terminal 10 to access the product sales web page created on the Internet 100 by the sales center (step A1 in FIG. 14). In response to this access, the sales center terminal 30 sends product information to the user terminal 10 (step A2 in FIG. 14). The user terminal 10, which has received the product information, displays it in the format shown in FIG. 13(1) (step A3 in FIG. 14). The shopper views the product information displayed on the screen of the user terminal 10, determines the product he or she wants to purchase, and fills out the screen to indicate that he or she is going to purchase the product (step A4 in FIG. 14). In the example shown in FIG. 13(1), when the shopper clicks the purchase column of product B with a mouse, the check mark appears in the column to indicate that product B has been selected for purchase. Information on the product the shopper has selected to purchase is temporarily stored in the user terminal 10.

Next, when the shopper clicks the “Purchase” button on the screen shown in FIG. 13(1) with a mouse, an input form such as the one shown in FIG. 13(2) is displayed on the screen to prompt the shopper to enter information necessary to purchase the product (step A5 in FIG. 14). The shopper confirms the product to purchase and then enters various types of information (step A6 in FIG. 14). Information the shopper enters includes personal information such as the address of the shopper (product delivery address), name, and telephone number, a payment method, and the personal identification number. In the example shown in FIG. 13 (2), the shopper clicks the check column of cash card 26 (bank card) of “Payment method” and enters the personal identification number (in this example, 1234) from the keyboard. This information is stored temporarily in the user terminal 10.

Then, when the shopper clicks the “Send” button on the screen shown in FIG. 13(2) with a mouse, the user terminal 10 accesses the cash card 26 (step A7 in FIG. 14) to read the account number from the cash card 26 (step A8 in FIG. 14). Upon receiving the account number from the cash card 26, the user terminal 10 sends product order information, which is composed of purchase product information, personal information, payment method information, and personal identification number 1234 stored in the user terminal 10, as well as the account number that was read, to the sales center terminal 30 (step A9 in FIG. 14).

Upon receiving the product order information (step A10 in FIG. 14), the sales center terminal 30 calculates the total amount from the purchase product information (step A11 in FIG. 14). Then, to settle the accounts with the cash card 26, the sales center terminal 30 sends transaction information, which is composed of shopper's personal information, account number, personal identification number 1234, transaction amount, and bank account to which the price is to be transferred (account number of the sales center and so on), to the banking terminal 41 (step A12 in FIG. 14).

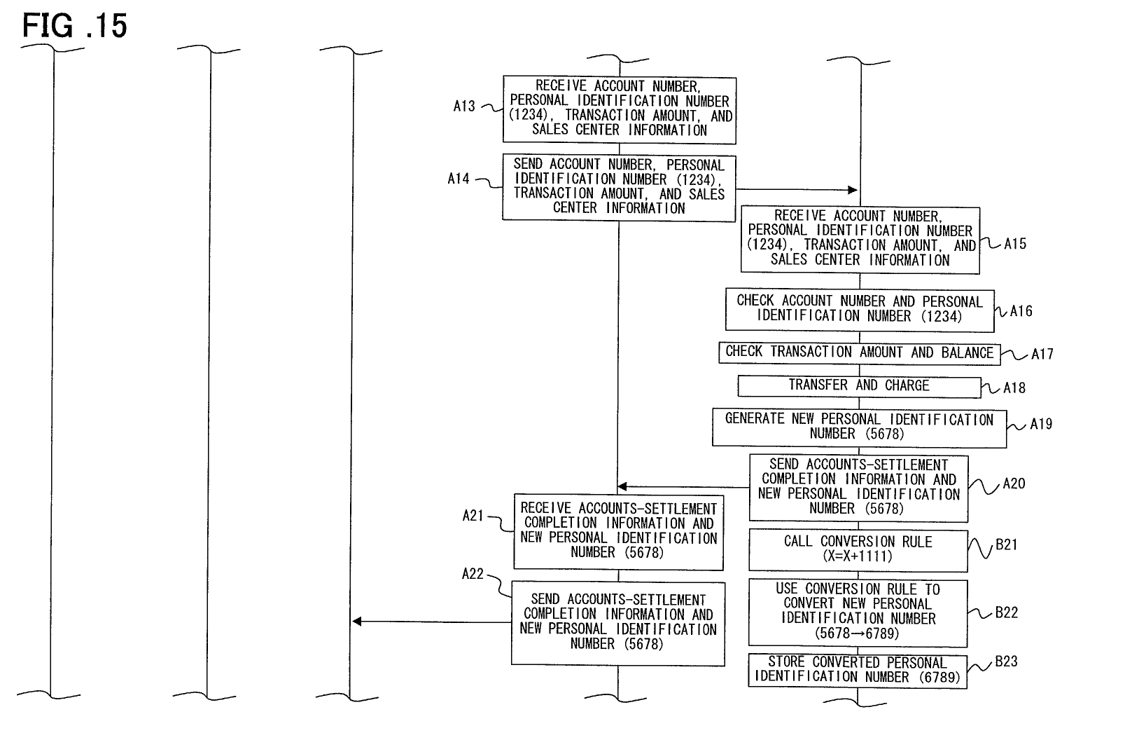

Upon receiving the transaction information (step A13 in FIG. 15), the banking terminal 41 sends the information to the customer database 50 (step A14 in FIG. 15) to check the transaction.

Upon receiving the transaction information (step A15 in FIG. 15), the customer database 50 checks the shopper based on the personal information and the personal identification number (step A16 in FIG. 15). If the information is incorrect, the customer database 50 sends an incorrect-information message to the shopper via the banking terminal 41, sales center terminal 30, and user terminal 10. After checking the shopper, the customer database 50 checks the transaction amount (step A17 in FIG. 15). If it is impossible to perform transaction, for example, if the transaction amount exceeds the allowable amount recorded on the cash card 26, the customer database 50 sends an invalid-transaction message to the shopper via the banking terminal 41, sales center terminal 30, and user terminal 10. If it is confirmed that there is no problem in performing the transaction, the customer database 50 settles the accounts (step A18 in FIG. 15). After accounts settlement, the customer database 50 generates a new personal identification number (step A19 in FIG. 15). As an example, assume that the personal identification number 5678 is generated.

The customer database 50 sends accounts settlement completion information indicating that the account settlement has been completed and the generated new personal identification number 5678 to the banking terminal 41 (step A20 in FIG. 15). After that, the customer database 50 calls the conversion rule for the cash card 26 (in this example, add 1111 to the personal identification number) recorded in the customer database 50 (step B21 in FIG. 15), uses this conversion rule to convert the generated new personal identification number from 5678 to 6789 (step B22 in FIG. 15), and records the converted personal identification number 6789 in the customer database 50 (step B23 in FIG. 15).

Upon receiving the accounts settlement completion information and the new personal identification number 5678 (step A21 in FIG. 15), the banking terminal 41 sends them to the sales center terminal 30 (step A22 in FIG. 15).

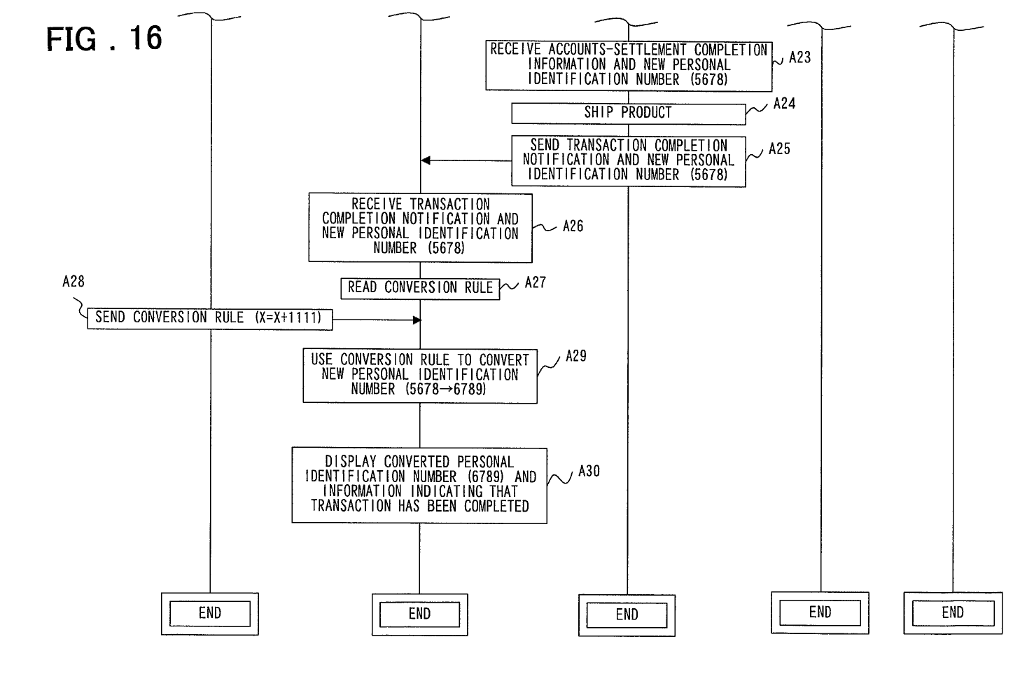

Upon receiving the accounts settlement completion information and the new personal identification number 5678 (step A23 in FIG. 16), the sales center terminal 30 ships the product (step A24 in FIG. 16). After that, the sales center terminal 30 sends a transaction completion notification indicating that the transaction has been completed and the new personal identification number 5678 to the user terminal 10 (step A25 in FIG. 16).

Upon receiving the transaction completion notification and the new personal identification number 5678, the user terminal 10 accesses the cash card 26 (step A27 in FIG. 16) to read the recorded conversion rule (x=x+1111) (step A28 in FIG. 16). The user terminal 10 uses this conversion rule to convert the new personal identification number from 5678 to 6789 (step A29 in FIG. 16). Finally, the user terminal 10 displays the new personal identification number 6789 and information indicating that the transaction has been completed (step A30 in FIG. 16) to inform the shopper that the transaction has been completed.

The first and second embodiments have been described. It is to be understood that the present invention is not limited to those embodiments. Other embodiments will be described below.

The credit card number conversion rule may be any rule that converts a credit card number transferred over a communication network. The conversion rule may converts a credit card number using a function as shown in the above embodiments or may replace one character string with another according to some rule. These methods may also be combined. The conversion rule may require a constant or a keyword. When a keyword is used in the conversion rule, the conversion method may be disclosed or shared, with only the keyword uniquely assigned to the card. Also, instead of sending a new credit card number, the current credit card number may be converted to another using a conversion rule.

Although converted by the user terminal 10 in the above embodiment, the credit card number may be converted by the card reader/writer 20. Or, the credit card 25 may have this function. Similarly, the credit card company terminal 40 or the banking terminal 41 may perform conversion performed by the customer database 50 in the above embodiments.

The present invention is applicable to the protection of not only credit card numbers and personal identification numbers but also ID numbers and passwords. For example, in a membership web site where a password is checked, converting a password with the use of a conversion rule prevents the password from being misused intentionally even if the password is stolen on the network.

The user terminal 10 need not be a personal terminal. For example, it may be a terminal installed in public facilities for use by a plurality of persons.

The present invention is applicable not only to products sold on a network but also to products sold in over-the-counter transactions. For example, the present invention is used by a terminal installed in a retail store that processes payment. This prevents the intentional misuse of information when information is stolen between a retail store terminal and the credit card company terminal (or banking terminal).

The credit card 25 may be any medium that sends data to, or receives data from, the user terminal 10 connected to the Internet 100. For example, the medium may be a credit card using magnetic recording or a card including an IC chip. The medium need not be a card but may be a flash memory card. The medium may also be a medium using a magnetic or optical recording technology such as a floppy disk.

The user terminal 10 and the card reader/writer 20 need not be separate but may be integrated into one. Also, the credit card company terminal 40 (or banking terminal 41) and the customer database 50 may be integrated.

The meritorious effects of the present invention are summarized as follows.

The user authentication device according to the present invention permits an authentication number to be used only once, preventing unauthorized access from being made by a “pretender” even if the authentication number is stolen by an unauthorized person. Moreover, the transaction system according to the present invention uses the user authentication device according to the present invention to recognize users correctly, enabling an electric transactions to be made securely on a communication network.

In other words, the present invention has the following four advantages.

The first advantage is that an authentication number, such as a credit card number and a personal identification number, on a communication network is not intentionally misused even if stolen by someone else. This is because someone else who has stolen a credit card number cannot use the card because a credit card number is created for each transaction.

The second advantage is that a conversion rule for converting authentication numbers such as credit card numbers and personal identification numbers will not be stolen. This is because a conversion rule for credit card numbers and so on is pre-recorded on a credit card and because conversion of credit card numbers and so on is performed locally. This prevents information on converting credit card numbers from being sent to the network.

The third advantage is that the present invention has eliminated the need for the cumbersome input of a credit card number. The reason is that the user terminal reads a number from a credit card for transmission to the user, thus eliminating the need for the user to enter the number.

The fourth advantage is that an input error of a credit card number is eliminated. The reason is that the user terminal reads a number from a credit card for transmission to the user, thus eliminating the need for the user to enter the number.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A user authentication device to which a user information processor and an authentication information processor are connected over a communication network,
wherein said user information processor comprises:
a function unit for sending a first authentication number to said authentication information processor; and
a function unit for converting the first authentication number to a second authentication number using a predetermined conversion rule in response to an access permission notification from said authentication information processor and for using the second authentication number as a new first authentication number, and
wherein said authentication information processor comprises:
a function unit for making a check using a database in response to the first authentication number from said user information processor;
a function unit for sending the access permission notification to said user information processor if a user is authenticated as valid as a result of the check; and
a function unit for converting the first authentication number to a second authentication number using the same conversion rule after sending the access permission notification and for recording the second authentication number into the database as a new first authentication number.

2. The user authentication device as defined by claim 1,
wherein said user information processor comprises:
a portable recording medium;
a function unit for reading a first authentication number and a predetermined conversion rule from said portable recording medium and for sending the first authentication number to said authentication information processor; and
a function unit for converting the first authentication number to a second authentication number using the conversion rule in response to the access permission notification and for recording the second authentication number on said portable recording medium as a new first authentication number.

3. The user authentication device as defined by claim 1,
wherein said user information processor comprises:
a portable recording medium; and
a function unit for reading a first authentication number from said portable recording medium and for sending the first authentication number to said authentication information processor, and
wherein said portable recording medium comprises a function unit for converting the first authentication number to a second authentication number using a predetermined conversion rule in response to the access permission notification and for recording the second authentication number on said portable recording medium as a new first authentication number.

4. The user authentication device as defined by claim 1,
wherein said user information processor comprises:
a portable recording medium;
a function unit for receiving a first authentication number and sending the first authentication number to said authentication information processor; and
a function unit for reading a predetermined conversion rule from said portable recording medium, for converting the first authentication number to a second authentication number using the conversion rule in response to the access permission notification, and for outputting the second authentication number as a new first authentication number.

5. A user authentication device to which a user information processor, a mediator information processor, and an authentication information processor are connected over a communication network,
wherein said user information processor comprises:
a function unit for sending a first authentication number to said mediator information processor; and
a function unit for converting a second authentication number to a third authentication number using a predetermined conversion rule in response to the second authentication number from said mediator information processor and for using the third authentication number as a new first authentication number,
wherein said mediator information processor comprises:
a function unit for sending the first authentication number to said authentication information processor, said first authentication number being received from said user information processor; and
a function unit for receiving the second authentication number from said authentication information processor and for sending the second authentication number to said user information processor, and
wherein said authentication information processor comprises:
a function unit for making a check using a database in response to the first authentication number from said mediator information processor and for sending the second authentication number to said mediator information processor if a user is authenticated as valid as a result of the check, the second authentication number being different from the first authentication number; and
a function unit for converting the second authentication number to a third authentication number using the same conversion rule and for recording the third authentication number into the database as a new first authentication number.

6. The user authentication device as defined by claim 5,
wherein said user information processor comprises:
a portable recording medium;
a function unit for reading a first authentication number and a predetermined conversion rule from said portable recording medium and for sending the first authentication number to said mediator information processor; and
a function unit for converting the second authentication number to a third authentication number using the conversion rule in response to the second authentication number and for recording the second authentication number on said portable recording medium as a new first authentication number.

7. The user authentication device as defined by claim 5,
wherein said user information processor comprises:
a portable recording medium; and
a function unit for reading a first authentication number from said portable recording medium and for sending the first authentication number to said mediator information processor, and
wherein said portable recording medium comprises a function unit for converting the second authentication number to a third authentication number using a predetermined conversion rule in response to the second authentication number and for recording the third authentication number on said portable recording medium as a new first authentication number.

8. The user authentication device as defined by claim 5,
wherein said user information processor comprises:
a portable recording medium;
a function unit for receiving a first authentication number and sending the first authentication number to said mediator information processor; and
a function unit for reading a predetermined conversion rule from said portable recording medium, for converting the second authentication number to a third authentication number using the conversion rule in response to the second authentication number, and for outputting the third authentication number as a new first authentication number.

9. A transaction system using the user authentication device as defined by claim 2,
wherein said user information processor sends the first authentication number and an accounts-settlement request to said authentication information processor,
wherein said authentication information processor executes the check and account-settlement processing, and wherein said communication network is the Internet,
said user information processor is a terminal in a retail store,
said authentication information processor is a credit card company terminal,
said portable recording medium is a credit card, and
said authentication number is a credit card number.

10. A transaction system using the user authentication device as defined by claim 3,
wherein said user information processor sends the first authentication number and an accounts-settlement request to said authentication information processor,
wherein said authentication information processor executes the check and account-settlement processing, and
wherein said communication network is the Internet,
said user information processor is a terminal in a retail store,
said authentication information processor is a credit card company terminal,
said portable recording medium is a credit card, and
said authentication number is a credit card number.

11. A transaction system using the user authentication device as defined by claim 4,
wherein said user information processor sends the first authentication number and an accounts-settlement request to said authentication information processor,
wherein said authentication information processor executes the check and account-settlement processing, and
wherein said communication network is the Internet,
said user information processor is a terminal in a retail store,
said authentication information processor is a banking terminal,
said portable recording medium is a cash card, and
said authentication number is a personal identification number.

12. A transaction system using the user authentication device as defined by claim 6,
wherein said mediator information processor sends the first authentication number and an accounts-settlement request to said authentication information processor,
wherein said authentication information processor executes the check and account-settlement processing, and
wherein said communication network is the Internet,
said user information processor is a user terminal,
said mediator information processor is a sales center terminal,
said authentication information processor is a credit card company terminal,
said portable recording medium is a credit card, and
said authentication number is a credit card number.

13. A transaction system using the user authentication device as defined by claim 7,
wherein said mediator information processor sends the first authentication number and an accounts-settlement request to said authentication information processor,
wherein said authentication information processor executes the check and account-settlement processing, and
wherein said communication network is the Internet,
said user information processor is a user terminal,
said mediator information processor is a sales center terminal,
said authentication information processor is a credit card company terminal,
said portable recording medium is a credit card, and
said authentication number is a credit card number.

14. A transaction system using the user authentication device as defined by claim 8,
wherein said mediator information processor sends the first authentication number and an accounts-settlement request to said authentication information processor,
wherein said authentication information processor executes the check and account-settlement processing, and
wherein said communication network is the Internet,
said user information processor is a user terminal,
said mediator information processor is a sales center terminal,
said authentication information processor is a banking terminal,
said portable recording medium is a cash card, and
said authentication number is a personal identification number.

15. A user authentication method comprising the steps of;
(a) providing a user authentication device having an authentication information processor to which a user information processor is connectable over a communication network,
(b) receiving a first authentication number from said user information processor;
(c) making a check using a database in response to the first authentication number from said user information processor;
(d) sending an access permission notification to said user information processor if a user is authenticated as valid as a result of the check; and
(e) converting the first authentication number to a second authentication number using the same conversion rule after sending the access permission notification and recording the second authentication number into the database as a new first authentication number, and
(f) letting said user information processor to convert the first authentication number to a second authentication number using a predetermined conversion rule in response to an access permission notification from said authentication information processor, and to use the second authentication number as a new first authentication number.

16. The user authentication method as defined by claim 15,
wherein said device causes said user information processor to perform:
reading a first authentication number and a predetermined conversion rule from a portable recording medium and sending the first authentication number to said device;
converting the first authentication number to a second authentication number using the conversion rule in response to the access permission notification; and
recording the second authentication number on said portable recording medium as a new first authentication number.

17. The user authentication method as defined by claim 15,
wherein said device causes said user information processor to perform:
reading a first authentication number from a portable recording medium and sending the first authentication number to said authentication information processor, and
wherein said device causes said portable recording medium to perform:
converting the first authentication number to a second authentication number using a predetermined conversion rule in response to the access permission notification and
recording the second authentication number on said portable recording medium as a new first authentication number.

18. The user authentication method as defined by claim 15,
wherein said device causes said user information processor to perform:
receiving a first authentication number and sending the first authentication number to said authentication information processor; and
reading a predetermined conversion rule from said portable recording medium, converting the first authentication number to a second authentication number using the conversion rule in response to the access permission notification, and outputting the second authentication number as a new first authentication number.

19. A user authentication method comprising the steps of:
(a) providing a user authentication device having an authentication information processor to which a user information processor and a mediator information processor are connectable over a communication network,
(b) causing said user information processor to send a first authentication number to said mediator information processor;
(c) causing said mediator information processor to send the first authentication number received from said user information processor to said authentication information processor;
(d) making a check by said authentication information processor using a database in response to the first authentication number from said mediator information processor and sending the second authentication number to said mediator information processor if a user is authenticated as valid as a result of the check, the second authentication number being different from the first authentication number;
(e) converting the second authentication number by said authentication information processor to a third authentication number using the same conversion rule and recording the third authentication number into the database as a new first authentication number;
(f) causing said mediator information processor to receive the second authentication number from said authentication information processor and to send the second authentication number to said user information processor, and
(g) causing said user information processor to convert a second authentication number to a third authentication number using a predetermined conversion rule in response to the second authentication number from said mediator information processor and to use the third authentication number as a new first authentication number.

20. The user authentication method as defined by claim 19,
wherein said user information processor is caused to perform:
reading a first authentication number and a predetermined conversion rule from a portable recording medium and sending the first authentication number to said mediator information processor; and
converting the second authentication number to a third authentication number using the conversion rule in response to the second authentication number, and
recording the second authentication number on said portable recording medium as a new first authentication number.

21. The user authentication method as defined by claim 19,
wherein said user information processor is caused to perform:
reading a first authentication number from a portable recording medium and sending the first authentication number to said mediator information processor, and
wherein said portable recording medium is caused to convert the second authentication number to a third authentication number using a predetermined conversion rule in response to the second authentication number, and to record the third authentication number on said portable recording medium as a new first authentication number.

22. The user authentication method as defined by claim 19,
wherein said user information processor is caused to perform:
receiving a first authentication number and sending the first authentication number to said mediator information processor; and
reading a predetermined conversion rule from a portable recording medium, converting the second authentication number to a third authentication number using the conversion rule in response to the second authentication number, and outputting the third authentication number as a new first authentication number.

23. A transaction method using the user authentication method as defined by claim 16,
wherein said user information processor is caused to send the first authentication number and an accounts-settlement request to said authentication information processor,
wherein said authentication information processor executes the check and account-settlement processing, and
wherein said communication network is the Internet,
said user information processor is a terminal in a retail store,
said authentication information processor is a credit card company terminal,
said portable recording medium is a credit card, and
said authentication number is a credit card number.

24. A transaction method using the user authentication method as defined by claim 17,
wherein said user information processor is caused to send the first authentication number and an accounts-settlement request to said authentication information processor,
wherein said authentication information processor executes the check and account-settlement processing, and
wherein said communication network is the Internet,
said user information processor is a terminal in a retail store,
said authentication information processor is a credit card company terminal,
said portable recording medium is a credit card, and
said authentication number is a credit card number.

25. A transaction method using the user authentication method as defined by claim 18,
wherein said user information processor is caused to send the first authentication number and an accounts-settlement request to said authentication information processor,
wherein said authentication information processor executes the check and account-settlement processing, and
wherein said communication network is the Internet,
said user information processor is a terminal in a retail store,
said authentication information processor is a credit card company terminal,
said portable recording medium is a cash card, and
said authentication number is a personal identification number.

26. A transaction method using the user authentication method as defined by claim 20,
wherein said mediator information processor is caused to send the first authentication number and an accounts-settlement request to said authentication information processor,
wherein said authentication information processor executes the check and account-settlement processing, and
wherein said communication network is the Internet,
said user information processor is a user terminal,
said mediator information processor is a sales center terminal,
said authentication information processor is a credit card company terminal,
said portable recording medium is a credit card, and
said authentication number is a credit card number.

27. A transaction method using the user authentication method as defined by claim 21,
wherein said mediator information processor is caused to send the first authentication number and an accounts-settlement request to said authentication information processor,
wherein said authentication information processor executes the check and account-settlement processing, and
wherein said communication network is the Internet,
said user information processor is a user terminal,
said mediator information processor is a sales center terminal,
said authentication information processor is a credit card company terminal,
said portable recording medium is a credit card, and
said authentication number is a credit card number.

28. A transaction method using the user authentication device as defined by claim 22,
wherein said mediator information processor is caused to send the first authentication number and an accounts-settlement request to said authentication information processor,
wherein said authentication information processor executes the check and account-settlement processing, and
wherein said communication network is the Internet,
said user information processor is a user terminal,
said mediator information processor is a sales center terminal,
said authentication information processor is a banking terminal,
said portable recording medium is a cash card, and
said authentication number is a personal identification number.
